(19) United States
(12) Patent Application Publication
(10) Pub. No.: US 2008/0069281 A1
(43) Pub. Date: Mar. 20, 2008

(54) STATISTICAL FEEDBACK FOR MIMO TRANSMIT BEAMFORMING

(75) Inventors: Robert Lind Olesen, Huntington, NY (US); Yingxue Li, Exton, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/834,984

(22) Filed: Aug. 7, 2007

Related U.S. Application Data
(60) Provisional application No. 60/822,132, filed on Aug. 11, 2006.

(51) Int. Cl. H04L 1/02

(52) U.S. Cl. 375/367

(57) ABSTRACT

The present invention comprises a method of statistical feedback for Multiple In-Multiple Out (MIMO) transmit beamforming comprising combining a short term channel state information and long term statistics in deriving a precoding matrix. At least one measurable parameter is observed, and a forgetting factor is determined based upon the observed parameter.

### CROSS REFERENCE TO RELATED APPLICATION

This application claims the benefit of U.S. provisional Application No. 60/822,132, filed on Aug. 11, 2006, which is incorporated by reference as if fully set forth.

### FIELD OF INVENTION

The present invention relates to prefiltering and feedback in Multiple In-Multiple Out (MIMO) systems. In particular, the present invention relates to statistical feedback for MIMO transmit beamforming.

### BACKGROUND

Orthogonal frequency division multiplexing (OFDM) is a data transmission scheme where the data is split into smaller streams and each stream is transmitted using a sub-carrier with a smaller bandwidth than the total available transmission bandwidth. The efficiency of OFDM is a result of the fact that the sub-carriers are selected so that they are orthogonal to each other. In other words, the sub-carriers do not interfere with each other while each is carrying a portion of the total user data.

There are practical reasons why OFDM may be preferred over other transmission schemes such as Code Division Multiple Access (CDMA). When the user data is split into streams carried by different sub-carriers, the effective data rate on each sub-carrier is less than the total data rate. Therefore, the symbol duration is much larger. Large symbol duration can tolerate larger delay spreads. In other words, data that is transmitted with a large symbol duration is not affected by multipath as severely as symbols with a shorter duration. OFDM symbols can tolerate delay spreads that are typical in wireless communications and do not require complicated receiver designs to recover from multipath delay.

Multiple Input—Multiple Output Orthogonal Frequency Division Multiplexing (MIMO OFDM) and MIMO Single Carrier Frequency Division Multiplexing Access (SC-FDMA) are air interface technologies used for high data throughput (HT) services. Various forms of transmit beamforming are currently being considered for these technologies, including eigen-beamforming, spatial multiplexing, and space time coding. Each of these techniques, though, require channel state information to be available at the transmitter in order to enable the maximum achievable capacity. Because the amount of information required for feedback may be excessive for a practical system, methods to reduce the amount of required feedback have been developed. Methods for reducing feedback include codebook methods, phase quantization methods, open loop methods including channel sounding, and statistical prefiltering.

Statistical prefiltering is a technique used to improve the performance of MIMO transmission when closed loop beamforming is used, specifically eigen-beamforming or precoding (TxBF), while keeps feedback overhead minimum. Several theorems for statistical prefiltering have been proved which provide upper and lower bounds in Symbol Error Rate (SER) and Throughput for MIMO TxBF. Statistical prefiltering continues to be an actively researched area because it provides potential advantages for reduction of the requirements for channel state feedback.

In spite of the potential advantages for statistical feedback, there are still practical limitations to its use. Although statistical prefiltering results in a significant improvement in performance (i.e., capacity, throughput symbol error rate) over open loop MIMO schemes, it still does not perform as well as closed loop MIMO schemes that feedback accurate instantaneous channel state information. In addition, statistical feedback is only optimal for certain limited cases, such as high signal to noise ratio (SNR), strong transmit antenna correlation, and strong Ricean channel component. Since, in general, these limited cases are generally only partially satisfied, there exists a need for an improved method and system to specify the precoding matrix.

### SUMMARY

The present invention comprises a system and method to feedback less information than usually required by transmit beamforming. In a preferred embodiment, a short term channel state information and long term statistics are combined in the derivation for the transmit filter Q. Also a forgetting factor is applied to the long term statistics determined by observing several measurable parameters. In another embodiment, statistical information is estimated by exploring reciprocity of wireless channel.

### BRIEF DESCRIPTION OF THE DRAWINGS

The foregoing summary, as well as the following detailed description of the preferred embodiments of the present invention will be better understood when read with reference to the appended drawings, wherein:

FIG. 1 is a functional block diagram of a Wireless Transmit Receive Unit in accordance with the present invention.

FIG. 2 is a system model in accordance with the present invention for MIMO pre-filtering and detection; and

FIG. 3 is a graph depicting the variance of spatial correlation as a function of normalized frequency.

### DETAILED DESCRIPTION OF THE PREFERRED EMBODIMENTS

Although the features and elements of the present invention are described in the preferred embodiments in particular combinations, each feature or element can be used alone (without the other feature or elements of the preferred embodiments) or in various combinations with or without other features and elements of the present invention.

Hereafter, a wireless transmit/receive unit (WTRU) includes but is not limited to a user equipment, mobile station, fixed or mobile subscriber unit, pager, or any other type of device capable of operating in a wireless environment. When referred to hereafter, a base station includes but is not limited to a Node-B, site controller, access point or any other type of interfacing device in a wireless environment.

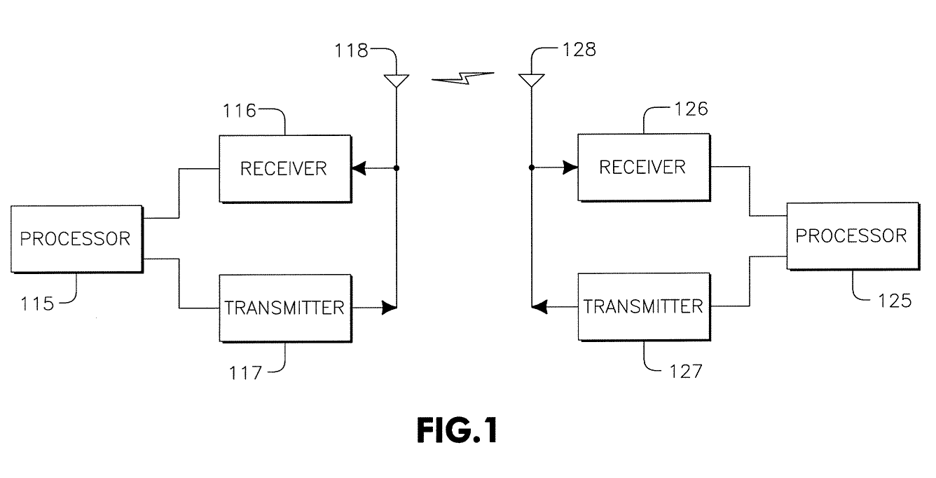

FIG. 1 is a functional block diagram of a transmitter and receiver 110, 120 configured to perform a method of Multiple Input—Multiple Output (MIMO) pre-filtering and detection in accordance with the present invention. In addition to components included in a typical transmitter/receiver, i.e., a WTRU or Node-B, transmitter and receiver 110, 120 includes processors 115, 125 configured to perform the method of MIMO pre-filtering and detection in accordance with the present invention, receivers 116, 126 in communication with processors 115, 125 transmitters 117, 127 in communication with processors 115, 125 and antenna 118, 128 in communication with receivers 116, 126 and transmitters 117, 127 to facilitate the transmission and reception of wireless data. Additionally, the receiver 116, transmitter 117 and antenna 118 maybe a single receiver, transmitter and antenna, or may include a plurality of individual receivers, transmitters and antennas, respectively. Transmitter 110 may be located at a WTRU or multiple transmitting circuits 110 may be located at a base station. Receiver 120 may be located at either the WTRU, base station, or both. For purposes of a preferred embodiment of the present invention, wireless data is transmitted and received over an orthogonal frequency division multiplexing (OFDM) wireless communication system.

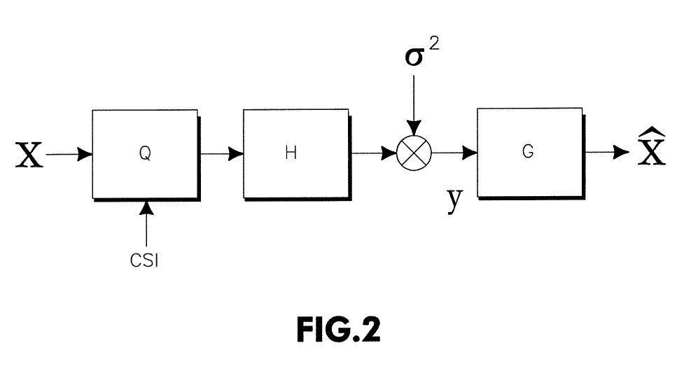

FIG. 2 is an illustration of a system model for MIMO pre-filtering and detection. In accordance with this example system model, Q is a MIMO pre-filter in accordance with a preferred embodiment of a present invention, H is the propagation channel, σ² is white Gaussian noise, CSI is the channel state information obtained by processor 115 of transmitter 110, and G is the MIMO detection algorithm. Also χ, and [symbol] are the source and estimated data signal and γ is the received signal at the receive array.

As is known to those having skill in the art, the propagation channel can be described by the following equation:
H=α^{H}H_{w}β (1)
where H_{w} is a M by N matrix of complex independent and identically distributed Gaussian variables for M receive antennas and N transmit antennas. The correlation at the transmitter 110 and receiver 120 are described by ββ^{H}=Rₜₓ and αα^{H}=Rᵣₓ, where Rₜₓ and Rᵣₓ describe long term stable correlations caused by antenna geometries.

As those skilled in the art know, the correlations are dependent on the antenna geometries for the transmitter 110 and receiver 120, respectively. As such, when either the antennas 118, 128 are more closely spaced, or the near field environment at either the transmitter 110 or receiver 120 causes the electromagnetic environment to be highly coupled, more correlation will occur.

Q is a MIMO pre-filter which, for no correlation and white noise, the optimum filter is derived from the singular value decomposition of the channel:
svd(H)=UDV^{H} (2)
Q=V
where it is assumed that a perfect estimate of H is available at transmitter 110. When transmit and/or receive correlation, and/or colored noise is present, the derivation for the optimum filter Q is given in equation (3), long term CSI, as:
Q=λφD (3)
where φ is a power loading matrix, D is a discrete Fourier transform (DFT) rotation matrix, and λ is a eigen-value matrix represented by Equation (4) as follows:
λ=EVD(H^{H}Rₙₙ⁻¹H) (4)
Rₙₙ=cov(σ²)

In a preferred embodiment, the procedure described in Equation 4 is conducted in processor 125 at receiver 120, and the resulting matrix λ is fed back to transmitter 110.

The general Minimum Mean Square Error (MMSE) solution for the MIMO detection algorithm G is preferably shown to be found by equation (4) and equation (5) as follows:
\hat{x}=(Rₓ⁻¹+H*Rₙₙ⁻¹H)⁻¹H*Rₙₙ⁻¹y (5)
where Rₓ and Rₙₙ designate the transmit signal and noise covariance matrices, respectively. The short term CSI as given in equation (4), and the long term CSI as in equation (3) may be defined as:
λ̅=EVD(E(H^{H}Rₙₙ⁻¹H)) (6)
R̅ₙₙ=E(cov(σ²))

It should be noted that the difference between equation (6) and (4) is that the eigen-value matrix is calculated and fed back at much slower rate. As can be seen in (6), the average over certain time period is done first before eigen value decomposition is performed.

In accordance with a preferred embodiment of the present invention, statistical pre-filtering and feedback is employed by combining the short term and long term channel state feedback. Accordingly, combining equations (3), (4), and (6) yields:
Q=(ρλ+(1−ρ) λ̅)φD (7)
where ρ is a single parameter introduced to define a forgetting factor vector applied to the long term channel state feedback λ and λ̅. It is preferable that ρ have a value ranging between 0 and 1. When instantaneous channel information is absent at transmitter 20. ρ is set to 0. A forgetting factor in accordance with the present invention is preferably a factor that determines how reliable, or how much to rely on the long term CSI. It should be noted that ρᵢ for the i^{th} eigen-mode may be different than for other eigen-modes. The optimum power loading matrix is dependent on the selection of ρ and also on the codeword used for λ at the transmitter. As known by those having skill in the art, the modulation and coding of a particular codeword is selected to match the eigen-power of the eigen-channel through which it is transmitted.

Processor 115 of transmitter 110 determines ρ based on several measurable parameters. The measurable parameters represent the variation in the channel, including but are not limited to, parameters such as, the change in receiver 120 speed, Doppler frequency, wireless channel delay spread, and signal to noise ratio. A larger ρ value indicates more weight should be put on instantaneous channel information, and a smaller ρ value indicates more weight should be put on statistical channel information. For example, when receiver 120 moves at a high speed, the instantaneous channel information feedback becomes outdated once it arrives at transmitter 110, therefore, processor 115 of transmitter 110 may decide to rely heavily on statistical information by setting ρ to a smaller value. In another example, when receiver 120 speed is low and SNR is high, processor 115 of transmitter 110 may decide to rely more on instantaneous channel information by setting ρ to a larger number.

In an alternative embodiment, an auxiliary matrix (W) may be defined to combine the short term and long term CSI for determining the precoding matrix as follows:
W=(1−ρ)E└H^{H}Rₙₙ⁻¹H┘+ρH^{H}Rₙₙ⁻¹H, (8)
\tilde{λ}=EVD(W), and
Q=\tilde{λ}φD.

For a Ricean channel only, the dominant eigen-mode will be present. Dominant eigen-mode transmission is supported by statistical feedback only leading to ρ=0.

At high signal to noise ratio (SNR), the importance of the weaker eigen-modes is much greater. Because the statistical description of the weaker eigen-modes is short lived, ρ must be at least greater than 0. However, depending on the ricean component of the channel, ρ may be less than 1.

For low SNR, the weaker eigen-modes may be dropped. For two or three antennas this is equivalent to dominant eigen-mode transmission. ρ is preferably approximately one for this case.

Alternatively, a measurable parameter by processor 115 may include the rank of the channel. Accordingly, ρ may be determined from a measurement of the rank of the channel at receiver 120, similar to rank reduction techniques currently considered in Long Term Evolution (LTE) for channel state feedback. Those having skill in the art know, the rank of the channel is defined by the maximum number of independent eigen-channels supported for transmission. For example, if there are 4 transmit and 4 receive antennas, the maximum rank that may be supported is 4, but certain channel conditions may limit the maximum rank attainable to 1 or 2 as defined by the number of independent rows or columns in the correlation matrix for the channel. Also, the SINR per codeword may also be used as well, for determining ρ. In accordance with the above, the statistical information is generated at transmitter 110 from the information fed back by receiver 120. In an alternative embodiment, the statistical information may be generated at receiver 120 directly and used to calculate prefiltering matrix Q. In this alternative, the method of determining the prefiltering matrix is in accordance with the method described above.

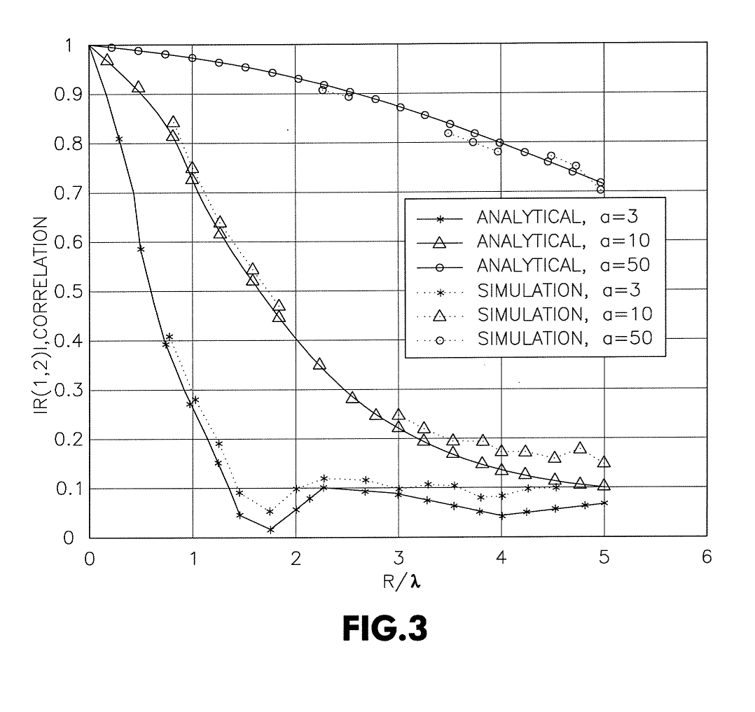

As described above, long term CSI is fed back to transmitter 110 to be combined with the short term CSI in order to select the precoding matrix. In accordance with another embodiment of the present invention, a method of determining the precoding matrix without the need of feeding back long term CSI can be employed, thereby reducing the feedback channel load. Although channel response itself can be very frequency selective, resulting in the violation of channel reciprocity, some second order statistics such as channel correlation are much less sensitive to frequency. This result exists in various antenna arrangement and RF propagation environments. FIG. 3 illustrates an example of how spatial correlation varies as a function of normalized frequency.

As such, in most commercial wireless networks, where total bandwidth (including both uplink and downlink) normalized by carrier frequency is small, spatial correlation can be assumed flat. Based on this assumption, an embodiment of the present invention comprises a system and method wherein the Node-B (transmitter 110) measures the received spatial correlation from the uplink traffic, and uses the measured spatial correlation for transmit pre-filtering (precoding) in the downlink, thereby eliminating the need for long term statistics being fed back to transmitter 110 for statistical pre-filtering.

For example, let channel matrix for the uplink channel be F. Transmitter 110 can estimate F by itself, without requiring feedback from receiver 120. In one embodiment transmitter 110 calculates downlink statistical information using the following formula.
λ̅≈EVD(E(F^{H}Rₙₙ⁻¹F)) (9)
Rₙₙ=cov(σ²)
Equation (9) is similar to equation (6). The difference, though, is that, in Equation (6), statistical information λ̅ is fed back by receiver 120; in Equation (9), transmitter 110 estimates the statistical information according to the uplink channel and, therefore, no statistical information feedback is needed. Once the statistical information is obtained, transmitter 110 can calculate the prefiltering matrix the same way as if the statistical information is fed back from receiver 120.
Q=(ρλ+(1−ρ) λ̅)φD (10)
In yet another embodiment, transmitter 110 calculates an augmented matrix using the following formula:
W=(1−ρ)E└F^{H}Rₙₙ⁻¹F┘+ρH^{H}Rₙₙ⁻¹H (11)
Wherein, the first term represents statistical information. When compared to Equation 8, it is noted that the statistical information can be estimated based on the uplink channel, rather than requiring receiver feedback. The prefiltering matrix is again calculated according to the following formula:
\tilde{λ}=EVD(W)
Q=\tilde{λ}φD

In an alternative embodiment, the Node-B (transmitter 110) would combine spatial correlation estimated from the uplink channel and short-term feedback from a WTRU (receiver 120) in determining transmit pre-filter in the downlink.

The present invention may be implemented in any type of wireless communication system, as desired. By way of example, the present invention may be implemented in any type of 802 type system, MIMO-OFDM, MIMO SC-FDMA, or any other type of wireless communication system. The present invention may also be implemented on an integrated circuit, such as an application specific integrated circuit (ASIC), multiple integrated circuits, logical programmable gate array (LPGA), multiple LPGAs, discrete components, or a combination of integrated circuit(s), LPGA(s), and discrete component(s).

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for specifying a precoding matrix at a transmitter using statistical prefiltering in an Orthogonal Frequency Domain Multiplexing Multiple Input—Multiple Output (OFDM MIMO) network comprising:
determining a long term channel state information;
determining a short term channel state information; and
combining said long term information and said short term information to generate said precoding matrix.

2. The method of claim 1 further comprising multiplying a forgetting factor (ρ) to said estimated long term channel state information.

3. The method of claim 2, wherein said short term channel information and said long term state information feedback are combined in accordance with the equation:
Q=(ρλ+(1−ρ) λ̅)φD
where λ and λ̅ is the long term channel state feedback.

4. The method of claim 3, wherein said forgetting factor is a measurable parameter.

5. The method of claim 3, wherein said measurable parameter is the traveling speed of said receiver.

6. The method of claim 3, wherein said measurable parameter is the signal to noise ratio.

7. The method of claim 3, wherein said measurable parameter is the doppler frequency.

8. The method of claim 3, wherein said measurable parameter is the delay spread of a communication channel.

9. The method of claim 4, wherein said forgetting factor is based on the rank of the communication channel between said transmitter and said receiver.

10. The method of claim 4 wherein said forgetting factor is determined using the signal to interference plus noise ratio.

11. The method of claim 3, wherein said long term channel state information is determined at said transmitter.

12. The method of claim 3, wherein said long term state information is determine at said receiver.

13. The method of claim 2, wherein said preceding matrix is calculated in accordance with the following equations:
W=(1−ρ)E└F^{H}Rₙₙ⁻¹F┘+ρH^{H}Rₙₙ⁻¹H,
\tilde{λ}=EVD(W), and
Q=\tilde{λ}φD

14. A transmitter for specifying a precoding matrix using statistical prefiltering in an Orthogonal Frequency Domain Multiplexing Multiple Input—Multiple Output (OFDM MIMO) network comprising:
a processor for determining a long term state information and combining said long term state information and said short term state information to calculate said precoding matrix.

15. The transmitter of claim 14, wherein said long term channel state information is multiplied by a forgetting factor (ρ).

16. The transmitter of claim 15, wherein said short term channel information and said long term statistical information feedback are combined in accordance with the equation:
Q=(ρλ+(1−ρ) λ̅)φD
where λ and λ̅ is the long term channel state feedback.

17. The transmitter of claim 16, wherein said forgetting factor is a measurable parameter.

18. The transmitter of claim 17, wherein said measurable parameter is the traveling speed of said receiver.

19. The transmitter of claim 17, wherein said measurable parameter is the signal to noise ratio.

20. The transmitter of claim 17, wherein said measurable parameter is the doppler frequency.

21. The transmitter of claim 17, wherein said measurable parameter is the delay spread of a communication channel.

22. The transmitter of claim 17, wherein said forgetting factor is based on the rank of the communication channel between said transmitter and said receiver.

23. The transmitter of claim 17, wherein said forgetting factor is determined using the signal to interference plus noise ratio.

24. The transmitter of claim 15, wherein said precoding matrix is calculated in accordance with the following equations:
W=(1−ρ)E└F^{H}Rₙₙ⁻¹F┘+ρH^{H}Rₙₙ⁻¹H,
\tilde{λ}=EVD(W), and
Q=\tilde{λ}φD

25. The transmitter of claim 15, wherein said transmitter is included in a wireless transmit receive unit.

26. The transmitter of claim 15, wherein said transmitter is included in a Node-B.

27. A method for specifying a precoding matrix at a transmitter using statistical prefiltering in an Orthogonal Frequency Domain Multiplexing Multiple Input—Multiple Output (OFDM MIMO) network comprising:
estimating long term channel state information based on an uplink channel;
determining a short term channel state information; and
combining said long term information and said short term information to generate said preceding matrix.

28. The method of claim 27, further comprising multiplying a forgetting factor (ρ) to said long term channel state information.

29. The method of claim 28, wherein said estimated long term channel information is determined in accordance with the equation:
λ̅≈EVD(E(F^{H}Rₙₙ⁻¹F)).

30. The method of claim 29, wherein said short term channel information and said estimated long term channel information are combined in accordance with the equation:
Q=λφD

31. The method of claim 30, wherein said forgetting factor is a measurable parameter.

32. The method of claim 30, wherein said measurable parameter is the traveling speed of said receiver.

33. The method of claim 30, wherein said measurable parameter is the signal to noise ratio.

34. The method of claim 30, wherein said measurable parameter is the doppler frequency.

35. The method of claim 30, wherein said measurable parameter is the delay spread of a communication channel.

36. The method of claim 31, wherein said forgetting factor is based on the rank of the communication channel between said transmitter and said receiver.

37. The method of claim 31, wherein said forgetting factor is determined using the signal to interference plus noise ratio.

38. The method of claim 28, wherein said precoding matrix is calculated in accordance with the following equations:
W=(1−ρ)E└F^{H}Rₙₙ⁻¹F┘+ρH^{H}Rₙₙ⁻¹H,
\tilde{λ}=EVD(W), and
Q=\tilde{λ}φD
